(19) United States
(12) Patent Application Publication
(10) Pub. No.: US 2015/0003127 A1
(43) Pub. Date: Jan. 1, 2015

(54) MULTILEVEL POWER CONVERSION CIRCUIT

(71) Applicant: FUJI ELECTRIC CO., LTD., Kawasaki-shi (JP)

(72) Inventor: Satoki TAKIZAWA, Hino-city (JP)

(21) Appl. No.: 14/301,524

(22) Filed: Jun. 11, 2014

(30) Foreign Application Priority Data
Jun. 26, 2013 (JP) 2013-133659

(51) Int. Cl. H02M 7/797

(52) U.S. Cl. CPC H02M 7/797
USPC 363/50; 363/123

(57) ABSTRACT

A multilevel power conversion circuit using a flying capacitor(s) can include two bidirectional switches connected in series between a middle potential terminal of DC power supplies and a conversion circuit using semiconductor switches. Gate driving circuits for the bidirectional switches are provided with a short-circuit fault detecting circuit for detecting short-circuit of the semiconductor switching device composing the bidirectional switch circuit in an OFF signal period. Upon detection of a short-circuit fault, all semiconductor switching devices are interrupted to stop the whole system.

### CROSS-REFERENCE TO RELATED APPLICATION

This application is based on, and claims priority to, Japanese Patent Application No. 2013-133659, filed on Jun. 26, 2013, the contents of which are incorporated herein by reference.

### BACKGROUND OF THE INVENTION

1. Field of the Invention

Embodiments of the invention relate to multilevel power conversion circuits for AC motor driving.

2. Description of the Related Art

FIG. 6 shows a power conversion circuit to convert a DC power to an AC power disclosed in Japanese Unexamined Patent Application Publication No. 2012-182974 and International Patent Publication Number WO/2007/087732. This is an example of five-level inverter circuit. The circuit comprises DC power supplies DP1 and DP2 connected in series each supplying a voltage of 2Ed. The DC power supply circuit including the power supplies DP1 and DP2 has a positive potential terminal P, a negative potential terminal N, and a middle potential terminal M. The DC power supplies can be constructed from an AC power supply system having a rectifier and a large capacity capacitor connected in series, though not illustrated in the figure.

The power conversion circuit of FIG. 6 includes series-connected eight semiconductor switches S1a, S1b, S1c, S2, S3, S4a, S4b, and S4c each being an IGBT with an antiparallel-connected diode between the positive potential terminal P and the negative potential terminal N. The series-connected semiconductor switches S1a, S1b, and S1c composes a first semiconductor switch group, and the series-connected semiconductor switches S4a, S4b, and S4c composes a second semiconductor switch group. The semiconductor switch S2 is a first semiconductor switch, and the semiconductor switch S3 is a second semiconductor switch. The first semiconductor switch group, S1a, S1b, and S1c, the first semiconductor switch S2, the second semiconductor switch S3, and the second semiconductor switch group, S4a, S4b, and S4c, are connected in series composing a first semiconductor switch series circuit.

Between the node between the semiconductor switch S1c of the first semiconductor switch group and the first semiconductor switch S2 and the node between the second semiconductor switch S3 and the semiconductor switch S4a of the second semiconductor switch group, connected is a parallel circuit of a series circuit of a semiconductor switch S5 and a semiconductor switch S6 and a capacitor C1. Between a point M, which is the node between the DC power supplies DP1 and DP2, and the node between the series-connected semiconductor switches S5 and S6, connected is a bidirectional switch capable of bidirectional switching comprising a reverse-blocking IGBTs S11 and S12 that are antiparallel-connected with each other. The bidirectional switch can be constructed in combination of IGBTs without reverse-blocking ability and diodes as shown in FIGS. 7A and 7B in addition to the circuit construction indicated in FIG. 6. The circuit of FIG. 7A has a construction having semiconductor switches Sa and Sb antiseries-connected (series-connected back-to-back) with the common collector terminal, each switch having an antiparallel-connected diode. The circuit of FIG. 7B has a construction having semiconductor switches Sa and Sb antiseries-connected with the common emitter terminal, each switch having an antiparallel-connected diode.

A flying capacitor C1 is controlled at a mean voltage of the unit voltage of Ed and capable of outputting an intermediate potential of the DC power supplies utilizing the charging and discharging action of the capacitor. The first and second semiconductor switch groups are connected to the positive potential terminal P or the negative potential terminal N and to the positive side terminal or the negative side terminal of the flying capacitor, and composed of three semiconductor switches connected in series. The reason for this construction is in order to equalize the withstand voltage rating of every semiconductor device. Here, the withstand voltage rating corresponds to the unit voltage Ed, which generally needs about 2Ed, corresponding to the maximum voltage applied to this section of the circuit. The series connection of three semiconductor switches is not necessary if a switching device of three times as high voltage rating is used at this section.

The power conversion circuit of FIG. 6 further includes gate driving circuits GDU-S1a through GDU-S4c, though only GDU-S1a and GDU-S4c are indicated in FIG. 6. The gate driving circuit delivers an ON/OFF signal from a control circuit CNT to a gate of each IGBT and detects a short-circuit fault signal and send it to the control circuit CNT. Because the gate driving circuit is provided for every IGBT, the control circuit CNT delivers 12 signals for one phase.

The circuit construction described above composes one phase, U-phase, and three sets of the construction composes a three phase inverter including three phases of U-phase, V-phase, and W-phase. The inverter system of FIG. 6 has a load of an AC motor LM. The inverter of this circuit construction delivers potentials to the AC output terminals of the converter at a potential levels of the P potential, the N potential, the M potential, and a P-Ed potential and an N+Ed potential by controlling ON/OFF operation of the semiconductor switches and the voltage of the capacitor C1. Thus, this conversion circuit is a five-level output inverter. FIG. 8 shows an example of waveform of output voltage Vout. The circuit of FIG. 6 generates smaller low order harmonics components and reduced switching loss in the switching devices as compared with a general two level type inverter. Thus, a high efficiency system can be constructed.

FIGS. 9 and 10 show basic circuits of multilevel conversion circuit including the five-level conversion circuit of FIG. 6. The circuit of FIG. 9 is variation of the circuit of FIG. 6 in which the semiconductor switches S2 and S3 are removed and the semiconductor switches S1a, S1b, and S1c are replaced by a switch Q1 and the semiconductor switches S4a, S4b, and S4c are replaced by a switch Q4. The circuit of FIG. 10 is another variation of the circuit of FIG. 6 in which the bidirectional switch BS1 in FIG. 10 performs the function of combination of the semiconductor switch S5 and the bidirectional switch consisting of the switches S11 and S12 in FIG. 6, and the bidirectional switch BS2 in FIG. 10 performs the function of combination of the semiconductor switch S6 and the bidirectional switch consisting of the switches S11 and S12 in FIG. 6. A multilevel conversion circuit of five levels or more can be constructed by adding a conversion circuit composed of semiconductor switches and other circuit components between the terminals TA1 and TB1 in FIG. 9 or between the terminals TA2 and TB2 in FIG. 10. The circuit of FIG. 6 is an example in which the semiconductor switches S2 and S3 are connected.

FIG. 15 shows an example of application circuit, which is one phase of a seven-level inverter with the semiconductor switching devices thereof having the same voltage rating that is a voltage rating corresponding to the one unit voltage Ed and generally needs a voltage rating of 2Ed. The circuit comprises DC power supplies DP1 and DP2 connected in series each delivering a voltage of 3Ed. The set of two power supplies has a positive potential terminal P, a negative potential terminal N, and a middle potential terminal M. The circuit of FIG. 15 has 12 semiconductor switches S1a through S1d, S2 through S5, and S6a through S6d connected in series between the positive potential terminal P and the negative potential terminal N, each semiconductor switch being an IGBT with an antiparallel-connected diode. The series circuit of semiconductor switches S1a through S1d compose a first semiconductor switch group, and the series circuit of semiconductor switches S6a through S6d compose a second semiconductor switch group. The semiconductor switch S2 is designated as a first semiconductor switch; the semiconductor switch S3, as a second semiconductor switch; the semiconductor switch S4, as a third semiconductor switch; and the semiconductor switch S5 is designated as a fourth semiconductor switch. The first semiconductor switch group of the semiconductor switches S1a through S1d, the first semiconductor switch S2, the second semiconductor switch S3, the third semiconductor switch S4, the fourth semiconductor switch S5, and the second semiconductor switch group of the semiconductor switches S6a through S6d are connected in series and compose a first semiconductor switch series circuit.

Between the node between the semiconductor switch S1d of the first semiconductor switch group and the first semiconductor switch S2 and the node between the fourth semiconductor switch S5 and the semiconductor switch S6a of the second semiconductor switch group, connected is a parallel circuit of a capacitor C1 and a second semiconductor switch series circuit consisting of series-connected semiconductor switches S7 through S10. A capacitor C2 is connected in parallel to the series-circuit of the second semiconductor switch S3 and the third semiconductor switch S4. A capacitor C3 is connected in parallel to a series circuit of a semiconductor switches S8 and S9. Between the middle potential point M, which is the series-connection point between the DC power supply DP1 and the DC power supply DP2, and the series-connection point between the semiconductor switches S8 and S9, connected is a bidirectional switch capable of bidirectional switching composed of reverse-blocking IGBTs S11 and S12 antiparallel-connected with each other. A bidirectional switch can be constructed by a combination of IGBTs without reverse-blocking ability and diodes as shown in FIG. 7A and FIG. 7B, as well as the one indicated in FIG. 15.

For the DC power supply voltage, 3Ed×2, seven levels of potentials can be delivered at the AC terminal by charging the capacitor C2 connected between the collector of the semiconductor switch S3 and the emitter of the semiconductor switch S4 at a voltage of one unit voltage Ed, charging the capacitor C1 connected between the collector of the semiconductor switch S2 and the emitter of the semiconductor switch S5 at a voltage of two unit voltages 2Ed, and charging the capacitor C3 connected between the collector of the semiconductor switch S8 and the emitter of the semiconductor switch S9 at a voltage of one unit voltage Ed. When all the semiconductor switching devices have the same voltage rating, the series-connected four semiconductor switches S1a through S1d form a semiconductor switch S1, and the series-connected four semiconductor switches S6a through S6d form a semiconductor switch S6 as shown in FIG. 15.

When all the IGBTs in the main circuit of FIG. 6 are turned OFF during their operation in general, solely the diodes in the semiconductor switch 1 consisting of switches S1a, S1b, and S1c or solely the diodes in the semiconductor switch 4 consisting of switches S4a, S4b, and S4c become conducting state as shown with the broken line in FIG. 11 to regenerate or send back the energy stored in the load inductances Lu, Lv, and Lw to the DC power supply side, resulting in zero current and finally system interruption.

If the IGBT 12 of the bidirectional switch suffers a short-circuit breakdown for some reason, a current to short-circuit the DC power supply DP2 flows through the flying capacitor C1 as shown by the broken line in FIG. 12 when the semiconductor switches S4a, S4b, and S4c are turned ON. This current flows through the path: DC power supply DP2→IGBT S12→diode of semiconductor switch S5→capacitor C1→semiconductor switches S4a, S4b, S4c→DC power supply DP2. If the IGBT 11 of the bidirectional switch suffers a short-circuit breakdown for some reason, a current to short-circuit the DC power supply DP1 flows through the flying capacitor C1 as shown by the broken line in FIG. 13 when the semiconductor switches S1a, S1b, and S1c are turned ON. This current flows through the path: DC power supply DP1→semiconductor switches S1a, S1b, S1c→capacitor C1→diode of semiconductor switch S6→IGBT S11→DC power supply DP1.

In a main circuit of a general two-level conversion circuit, if a semiconductor device in an upper arm or a lower arm suffers short-circuit breakdown and a power supply short-circuit current flows, the gate driving circuit of a switching device in a normal arm side detects short-circuit current to interrupt the whole gates to force whole the IGBTs into an OFF state, performing system shut down.

In the main circuit of the multilevel conversion circuit of FIG. 6, the gate driving circuits represented by GDU-S4c in FIG. 6 for the IGBTs composing the semiconductor switches S4a, S4b, and S4c, or the gate driving circuits represented by GDU S1a in FIG. 6 for the IGBTs composing the semiconductor switches S1a, S1b, and S1c detect the short-circuit current shown in FIG. 12 or the short-circuit current shown in FIG. 13. The gate driving circuits transmit occurrence of short-circuit to the control circuit CNT to turn all IGBTs' gates OFF. However, the short-circuit current continues to flow until the energy stored in the inductances Lu, Lv, and Lw of the load is completely dissipated. FIG. 14 shows the current flow when the IGBT S12 composing the bidirectional switch in the U-phase has undergone short-circuit breakdown and all IGBTs are interrupted. Because the IGBT S12 is short-circuited, the current to charge the flying capacitor C1 continues to flow resulting in overcharging of the capacitor C1. As a consequence, the semiconductor switch S2 connected in parallel with the capacitor C1 is also subjected to the overvoltage. Thus, the IGBT, diode, and the capacitor may be broken down as secondary damages.

The secondary damages could be avoided by raising the voltage ratings of the IGBT and diode composing the semiconductor switch and the capacitor, which however causes cost rise. In addition, because the inductance of a load cannot be known in advance, it is practically difficult to solve the problem of secondary damages by preliminary design.

### SUMMARY OF THE INVENTION

Embodiments of the invention provide a multilevel power conversion circuit provided with a protection means to avoid breakdown of an IGBT and diode composing another semiconductor switch and a capacitor when an IGBT composing a bidirectional switch has undergone short-circuit fault.

A first aspect of the invention is a multilevel power conversion circuit for converting DC power to AC power or AC power to DC power, one phase of which comprising: a first semiconductor switch series circuit connected between a positive potential terminal and a negative potential terminal of a DC power supply circuit having the positive potential terminal, the negative potential terminal, and a middle potential terminal, the first semiconductor switch series circuit being composed of: a first semiconductor switch group composed of a plurality of semiconductor switches connected in series, a first semiconductor switch, a second semiconductor switch, and a second semiconductor switch group composed of a plurality of semiconductor switches connected in series, these four components being connected in series in this order; a second semiconductor switch series circuit composed of a third semiconductor switch and a fourth semiconductor switch connected in series between a node between the first semiconductor switch group of the first semiconductor switch series circuit and the first semiconductor switch and a node between the second semiconductor switch and the second semiconductor switch group; a capacitor connected in parallel with the second semiconductor switch series circuit; and a bidirectional switch circuit capable of bidirectional switching connected between a series connection point of the second semiconductor switch series circuit and the middle potential terminal of the DC power supply circuit; the multilevel power conversion circuit having an AC terminal at a series connection point between the first semiconductor switch and the second semiconductor switch; and the bidirectional switch circuit having at least two semiconductor switching devices connected in series with the same current flowing direction.

A second aspect of the invention is a multilevel power conversion circuit for converting DC power to AC power or AC power to DC power, one phase of which comprising: a first semiconductor switch series circuit connected between a positive potential terminal and a negative potential terminal of a DC power supply circuit having the positive potential terminal, the negative potential terminal, and a middle potential terminal, the first semiconductor switch series circuit being composed of: a first semiconductor switch group composed of a plurality of semiconductor switches connected in series, a first semiconductor switch through a fourth semiconductor switch, and a second semiconductor switch group composed of a plurality of semiconductor switches connected in series, these six components being connected in series in this order; a second semiconductor switch series circuit composed of a fifth semiconductor switch through an eighth semiconductor switch connected in series between a node between the first semiconductor switch group of the first semiconductor switch series circuit and the first semiconductor switch and a node between the fourth semiconductor switch and the second semiconductor switch group; a first capacitor connected in parallel with the second semiconductor switch series circuit; a second capacitor connected in parallel with a series circuit of the second semiconductor switch and the third semiconductor switch; a third capacitor connected in parallel with a series circuit of the sixth semiconductor switch and the seventh semiconductor switch; and a bidirectional switch circuit capable of bidirectional switching connected between a node between the sixth semiconductor switch and the seventh semiconductor switch and the middle potential terminal of the DC power supply circuit; the multilevel power conversion circuit having an AC terminal at a series connection point between the second semiconductor switch and the third semiconductor switch; and the bidirectional switch circuit having at least two semiconductor switching devices connected in series with the same current flowing direction.

A third aspect of the invention is the multilevel power conversion circuit according to the first or second aspect of the present invention, wherein the bidirectional switch circuit comprising at least two semiconductor switching devices connected in series with the same current-flow direction is connected to a control means that has a voltage detection means that detects a voltage applied between main terminals in an OFF signal period and determines that a semiconductor switching device composing the bidirectional switch circuit is in a fault state if the voltage detected by the voltage detection means is approximately zero in the OFF signal period and the control means stops the power conversion circuit.

A fourth aspect of the invention is the multilevel power conversion circuit according to the third aspect of the invention, wherein the voltage detection means detects absence of a current flowing in the OFF signal period from a gate driving circuit for driving the bidirectional switch circuit to the main terminal of the semiconductor switching device composing the bidirectional switch circuit to determine that the voltage is approximately zero.

A fifth aspect of the invention is the multilevel power conversion circuit of nine levels or higher to which the multilevel power conversion circuit according to any one of claims 1 through 4 is applied.

In some embodiments, a multilevel power conversion circuit using a flying capacitor comprises at least two semiconductor switching devices composing bidirectional switches connected to a middle potential terminal of DC power supplies, the semiconductor switching devices being connected in series in the same current flowing direction. Short-circuit fault of one of the semiconductor switching devices composing the bidirectional switches is detected to stop the power conversion system. Consequently, when one of the semiconductor switching devices composing the bidirectional switches suffers short-circuit fault, the system can be safely stopped without breaking other semiconductor switches and capacitors.

### BRIEF DESCRIPTION OF DRAWINGS

FIG. 1 is a circuit diagram showing Embodiment Example 1 of the present invention;

FIGS. 2A-2D show examples of bidirectional switches that can be used in the circuit of Embodiment Example 1;

FIG. 3 shows a system construction of the circuit of Embodiment Example 1;

FIG. 4 shows an example of circuit operation of Embodiment Example 1;

FIG. 5 is a circuit diagram showing Embodiment Example 2 of the present invention;

FIG. 6 shows an example of conventional inverter circuit with a five-level conversion circuit;

FIGS. 7A and 7B show examples of bidirectional switches in conventional conversion circuits;

FIG. 8 shows an example of output waveform of conventional inverter circuit with a five-level conversion circuit;

FIG. 9 shows a first basic structure of a multilevel conversion circuit;

FIG. 10 shows a second basic structure of a multilevel conversion circuit;

FIG. 11 shows an example of current path when all switching devices are interrupted in an inverter circuit using a five-level conversion circuit;

FIG. 12 shows a short-circuit current path when short-circuiting has occurred in semiconductor switch S12 composing a bidirectional switch;

FIG. 13 shows a short-circuit current path when short-circuiting has occurred in semiconductor switch S11 composing a bidirectional switch;

FIG. 14 shows an example of current path when all semiconductor switching devices are interrupted in failure of the semiconductor switch S12;

FIG. 15 is a circuit diagram of one phase of a conventional seven-level conversion circuit; and

FIGS. 16A, 16B, and 16C show an example of gate driving circuit serving a function for short-circuit fault detection in an OFF state.

### DETAILED DESCRIPTION

In embodiments of the invention, a multilevel power conversion circuit of the invention is a five-level power conversion circuit, seven level power conversion circuit or higher levels of power conversion circuit. The five-level power conversion circuit comprises a first semiconductor switch series circuit connected between a positive potential terminal and a negative potential terminal of a DC power supply circuit having the positive potential terminal, the negative potential terminal, and a middle potential terminal, the first semiconductor switch series circuit comprising a first semiconductor switch group composed of a plurality of series-connected semiconductor switches, a first semiconductor switch, a second semiconductor switch, and a second semiconductor switch group composed of a plurality of semiconductor switches connected in series in this order. The five-level power conversion circuit also comprises a parallel circuit of a capacitor and a second semiconductor switch series circuit composed of series-connected third semiconductor switch and a fourth semiconductor switch between a node between the first semiconductor switch group and the first semiconductor switch and the node between the second semiconductor switch and the second semiconductor switch group. The five-level power conversion circuit further comprises a bidirectional switch circuit between the series connection point of the second semiconductor switch series circuit and the middle potential terminal of the DC power supply circuit. The five-level power conversion circuit has an AC terminal at the series connection point between the first semiconductor switch and the second semiconductor switch. A multilevel power conversion circuit of the invention is characterized in that the bidirectional switch circuit has at least two semiconductor switching devices connected in series with the same direction of current flow.

### Embodiment Example 1

FIG. 1 shows Embodiment Example 1 of the present invention. This is a circuit construction of one phase of a five-level power conversion circuit. Two sets of this circuit composes a single phase inverter circuit, and three sets of this circuit composes a three phase inverter circuit. By connecting a load at the AC terminal, this circuit can be operated as a DC to AC power conversion circuit; by connecting an AC power supply and a reactor (inductor) at the AC terminal, the circuit can be operated as an AC to DC power conversion circuit.

The circuit of FIG. 1 comprises a DC power supply circuit composed of DC power supplies DP1 and DP2 connected in series each delivering a voltage of 2Ed. The DC power supply circuit has a positive potential terminal P, a negative potential terminal N, and a middle potential terminal M.

Eight semiconductor switches S1a, S1b, S1c, S2, S3, S4a, S4b, and S4c are connected in series between the positive potential terminal P and the negative potential terminal N. Each semiconductor switch is an IGBT having a diode connected antiparallel to the IGBT. The series circuit of semiconductor switches S1a, S1b, and S1c composes a first semiconductor switch group, and the series circuit of semiconductor switches S4a, S4b, and S4c composes a second semiconductor switch group. The semiconductor switch S2 is referred to as a first semiconductor switch, and the semiconductor switch S3 is referred to as a second semiconductor switch. The first semiconductor switch group consisting of semiconductor switches S1a, S1b, and S1c, the first semiconductor switch S2, the second semiconductor switch S3, and the second semiconductor switch group consisting of semiconductor switches S4a, S4b, and S4c are connected in series in this order and composes a first semiconductor switch series circuit.

Between the node of the semiconductor switch S1c of the first semiconductor switch group and the first semiconductor switch S2 and the node between the second semiconductor switch S3 and the semiconductor switch S4a of the second semiconductor switch group, connected is a parallel circuit of a capacitor C1 and a second semiconductor switch series circuit consisting of semiconductor switches S5 and S6 connected in series. Between the middle potential terminal M, which is a series connection point of the DC power supplies DP1 and DP2, and the series connection point of the semiconductor switches S5 and S6, connected is a bidirectional switch circuit consisting of a first bidirectional switch and a second bidirectional switch connected in series, the first bidirectional switch being composed of reverse blocking IGBTs 11a and 12a connected antiparallel and capable of bidirectional switching and the second bidirectional switch being composed of reverse blocking IGBTs 11b and 12b connected antiparallel and capable of bidirectional switching.

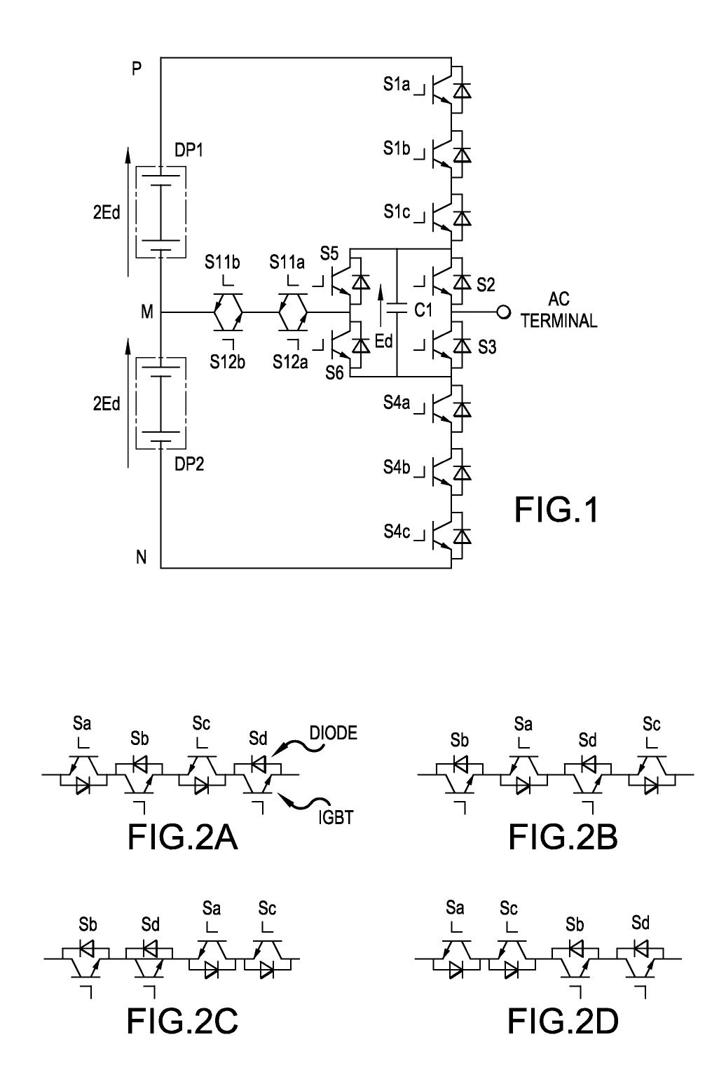

In addition to the circuit construction indicated in FIG. 1, a bidirectional switch circuit can be constructed by a combination of an IGBT without reverse blocking capability and diodes as shown in FIGS. 2A through 2D. The circuit of FIG. 2A is constructed by a series connection of a circuit having a semiconductor switch Sa with an antiparallel-connected diode and a semiconductor switch Sb with an antiparallel-connected diode, the two switches being antiseries-connected with a common collector terminal, and a circuit having a semiconductor switch Sc with an antiparallel-connected diode and a semiconductor switch Sd with an antiparallel-connected diode, the two switches being antiseries-connected with a common collector terminal. The circuit of FIG. 2B is constructed by a series connection of a circuit having a semiconductor switch Sa with an antiparallel-connected diode and a semiconductor switch Sb with an antiparallel-connected diode, the two switches being antiseries-connected with a common emitter terminal, and a circuit having a semiconductor switch Sc with an antiparallel-connected diode and a semiconductor switch Sd with an antiparallel-connected diode, the two switches being antiseries-connected with a common emitter terminal. The circuit of FIG. 2C is constructed by a series connection of a circuit having a semiconductor switch Sb with an antiparallel-connected diode and a semiconductor switch Sd with an antiparallel-connected diode, the two switches being series-connected, and a circuit having a semiconductor switch Sa with an antiparallel-connected diode and a semiconductor switch Sc with an antiparallel-connected diode, the two switches being series-connected, and the two circuits, each including the two semiconductor switches, being connected back to back with a common emitter terminal. The circuit of FIG. 2D is constructed by a series connection of a circuit having a semiconductor switch Sa with an antiparallel-connected diode and a semiconductor switch Sc with an antiparallel-connected diode, the two switches being series-connected, and a circuit having a semiconductor switch Sb with an antiparallel-connected diode and a semiconductor switch Sd with an antiparallel-connected diode, the two switches being series-connected, and the two circuits, each including the two semiconductor switches, being connected back to back with a common collector terminal.

The capacitor C1 is a flying capacitor. The average voltage across the capacitor is controlled at a unit voltage of Ed. Charging and discharging phenomena achieves output of intermediate potentials of the DC power supply circuit. The first semiconductor switch group is connected between the positive potential terminal P of the DC power supply circuit and the positive side terminal of the flying capacitor C1, and the second semiconductor switch group is connected between the negative potential terminal N of the DC power supply circuit and the negative side terminal of the flying capacitor C1. Each of the first and second semiconductor switch groups consists of series-connected three semiconductor switches in order that the semiconductor device of every semiconductor switch has the same withstand voltage rating that is a voltage rating corresponding to the unit voltage Ed, which generally needs about 2Ed, corresponding to the maximum voltage applied to this section of the circuit. The series connection of three semiconductor switches is not necessary if a switching device of three times as high voltage rating is used at this section.

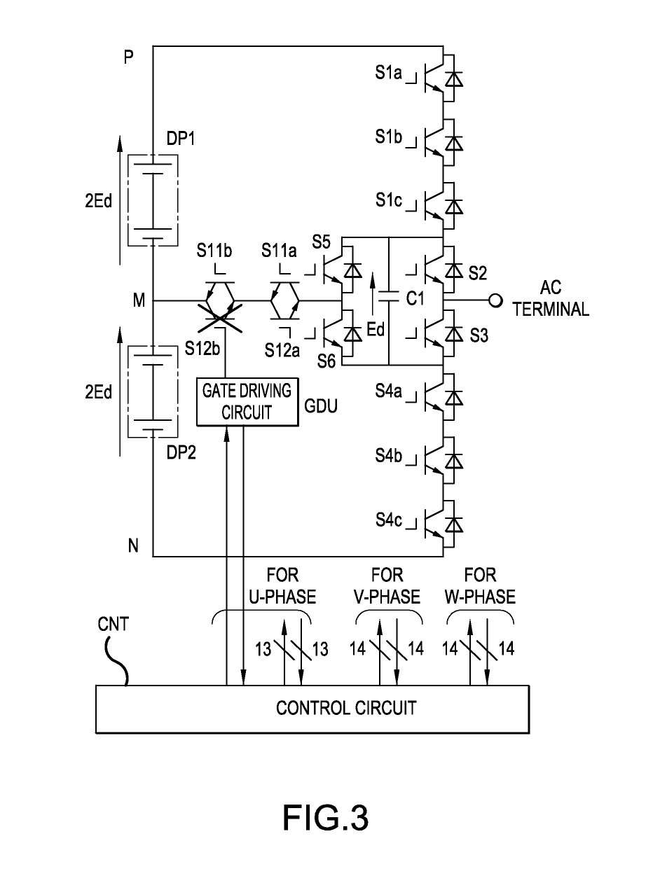

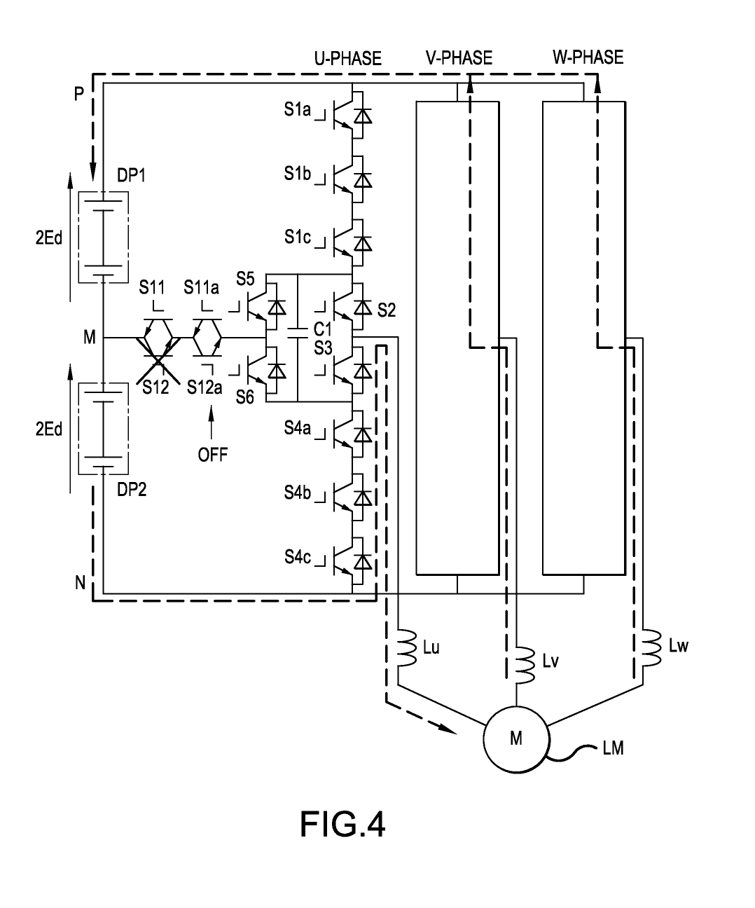

FIG. 3 shows a system construction to illustrate operation in the present invention. The main circuit is same as the one in FIG. 1. A gate driving circuit GDU is connected to every semiconductor switch although only one gate driving circuit is indicated in FIG. 3. Each gate driving circuit receives a driving signal from a control circuit CNT. Thus, the control circuit CNT delivers 14 signals for one phase. The gate driving circuits also have a function to detect and transmit a failure signal of short-circuit fault of the semiconductor switch.

The circuit construction described above composes one phase, U-phase, and three sets of the construction composes a three phase inverter including three phases of U-phase, V-phase, and W-phase. By connecting a load at the AC terminal, this circuit can be operated as a DC to AC power conversion circuit; by connecting an AC power supply and a reactor (inductor) at the AC terminal, the circuit can be operated as an AC to DC power conversion circuit. The conversion circuit of this circuit construction delivers potentials to the AC output terminal of the converter at a potential levels of the P potential, the N potential, the M potential, and a P−Ed potential and an N+Ed potential by controlling ON/OFF operation of the semiconductor switches and the voltage of the capacitor C1. Thus, this conversion circuit is a five-level inverter.

The following describes protection operation in this circuit construction when short-circuit fault has occurred in the reverse blocking IGBT S12b composing the bidirectional switch circuit. In the protection operation, a short-circuit fault state is detected by a failure detection circuit in an OFF period contained in the gate driving circuit that is connected to each of the series-connected IGBTs. The control circuit CNT receives the information of the failure and instructs to immediately stop the whole system based on the information.

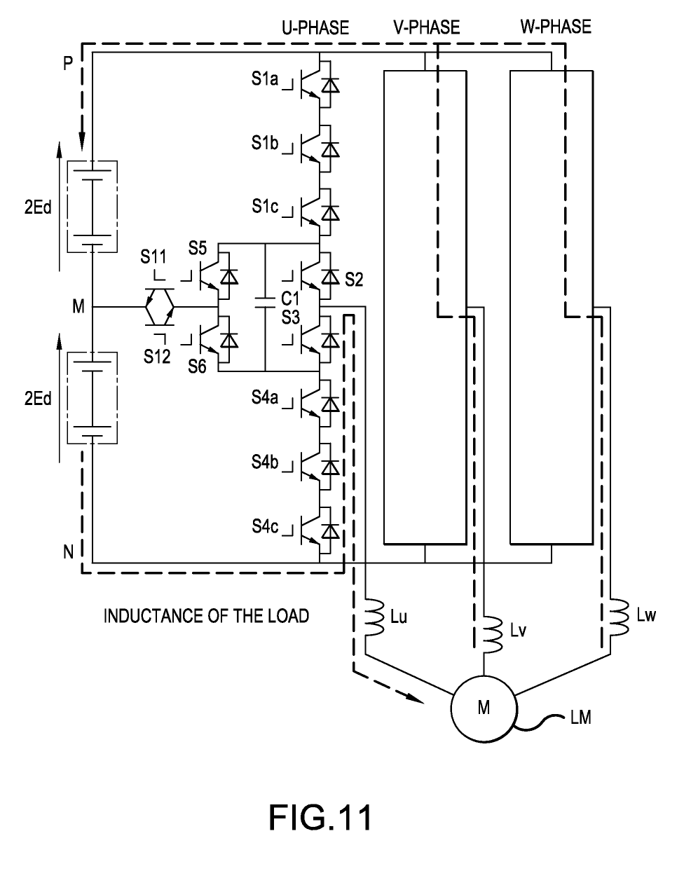

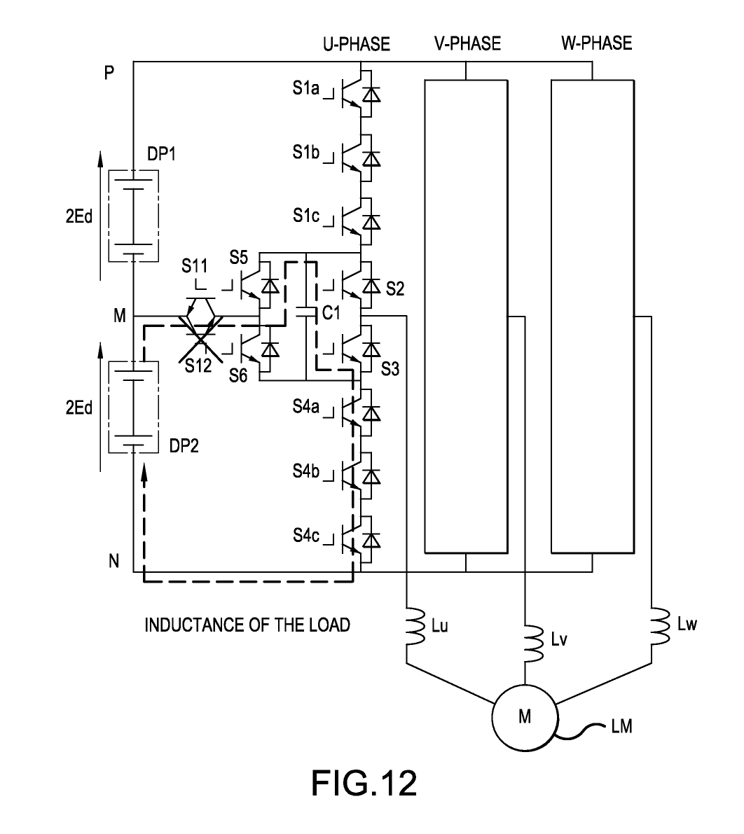

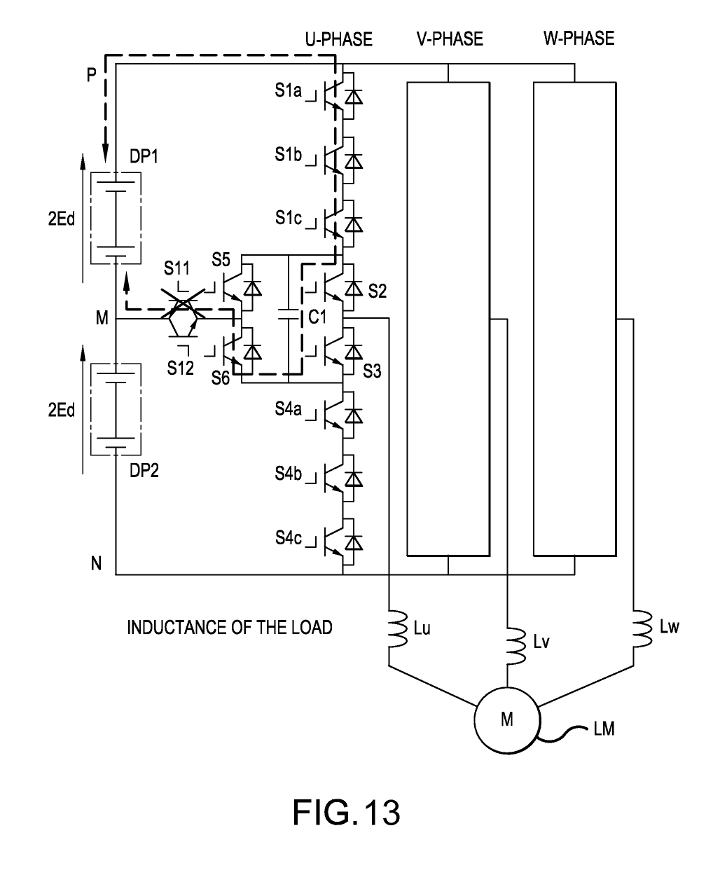

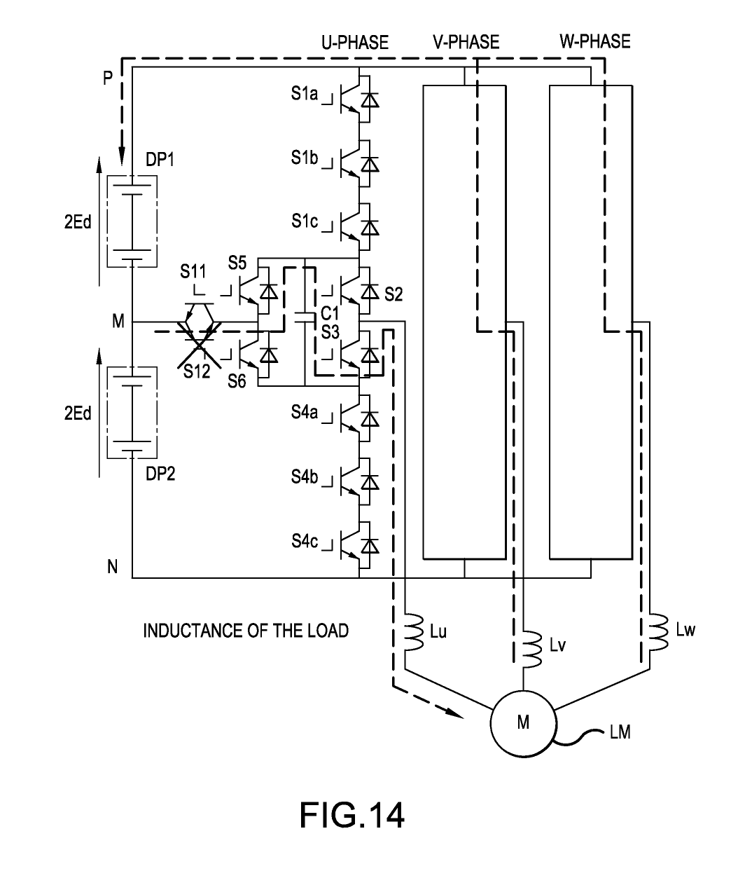

Because two semiconductor switching devices composing the bidirectional switch circuit are connected in series, when one of the series-connected two semiconductor switching devices, the semiconductor switching device S12b in the example of FIG. 3, has undergone short-circuit breakdown, the gate driving circuit GDU for the semiconductor switching device S12b detects the short-circuit fault, and then the control circuit CNT interrupts gate signals for all the semiconductor switches. Therefore, this protection system avoids over-charge and over-discharge of the capacitor through the current path as shown in FIG. 14 and stop the system in the circuit operation as shown in FIG. 11. For this reason, the gate driving circuit GDU is provided with a function to detect a short-circuit fault state in an OFF period.

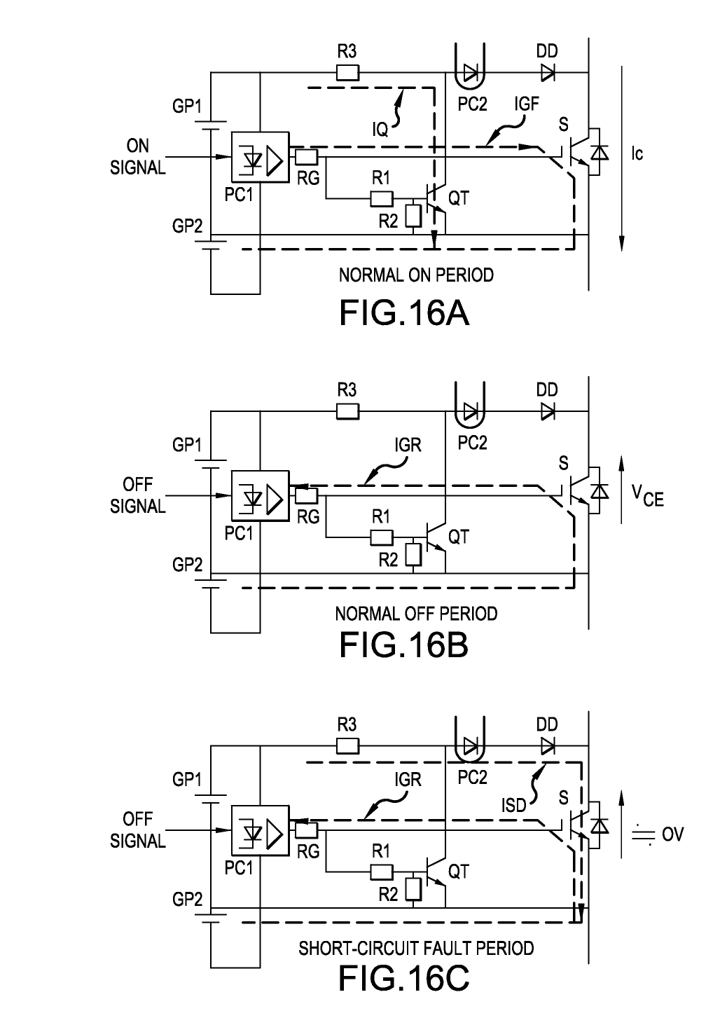

FIGS. 16A, 16B, and 16C show a basic circuit for detecting a short-circuit fault state in an OFF state. FIG. 16A shows operation in a normal ON state, FIG. 16B shows operation in a normal OFF state, and FIG. 16C shows operation in a short-circuit fault.

A photo-coupler PC1 with a gate driving function turns the IGBT ON/OFF based on an ON/OFF command signal from the primary side. A photo-coupler PC2 informs short-circuit fault of an IGBT of a semiconductor switch to the control circuit. The failure detection circuit comprises positive and negative current supplies GP1 and GP2 for gate driving, and a gate resistor RG for regulating a switching speed of the IGBT. A diode DD has a withstand voltage equal to that of the IGBT. A transistor QT is provided to inhibit operation of the photo-coupler PC2 for failure detection in an ON signal state, and the base terminal thereof is connected to resistors R1 and R2 and the collector terminal thereof is connected to a resistor R3 and the photo-coupler PC2. The resistor R3 is provided to limit the current through the photo-coupler PC2.

In the normal ON state of FIG. 16A, IGBT S is turned ON by current IGF and at the same time, the transistor QT turns ON to flow current IQ. In this state, the photodiode of the photo-coupler PC2 carries no current and thus emits no signal. In the normal OFF state of FIG. 16B, the IGBT S is turned OFF by current IGR. Because the diode DD is reverse biased in this state, the photo-coupler PC2 carries no current and emits no signal.

In the short-circuit fault state of the IGBTs shown in FIG. 16C, any voltage is virtually not applied between the collector and emitter of the IGBT S despite the OFF state, and current IGR, and current ISD from the positive power supply GP1 flows. Because the current ISD flows through a photodiode, which is a primary side diode of the photo-coupler PC2 series-connected to the diode DD, information of failure state is transmitted to the secondary side of the photo-coupler PC2, which is the control circuit side. However, the same operation can be assumed in the state a current is flowing in the diode antiparallel-connected to the IGBT S, which can occur in a dead time in a normal operation state. Consequently, a masking measure needs to determine no failure state by detecting polarity of the load current in the control circuit side, for example.

### Embodiment Example 2

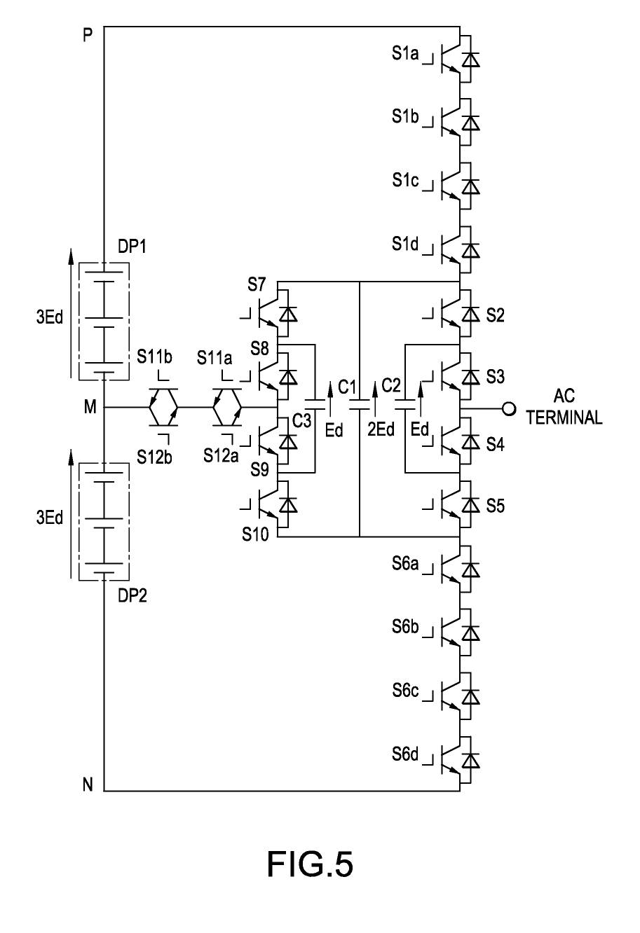

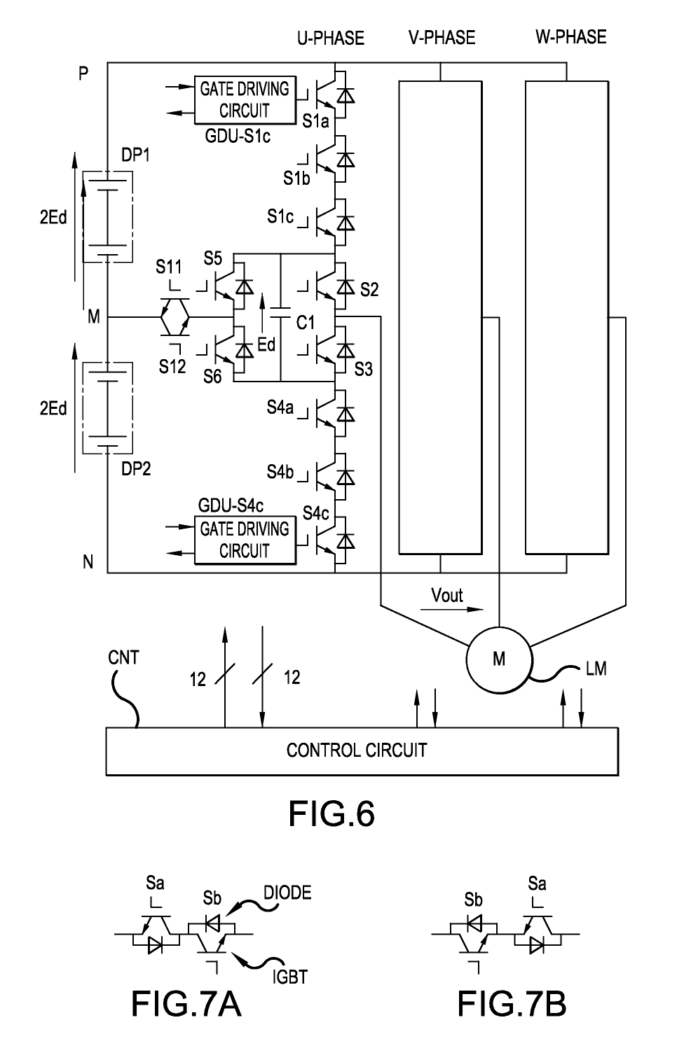

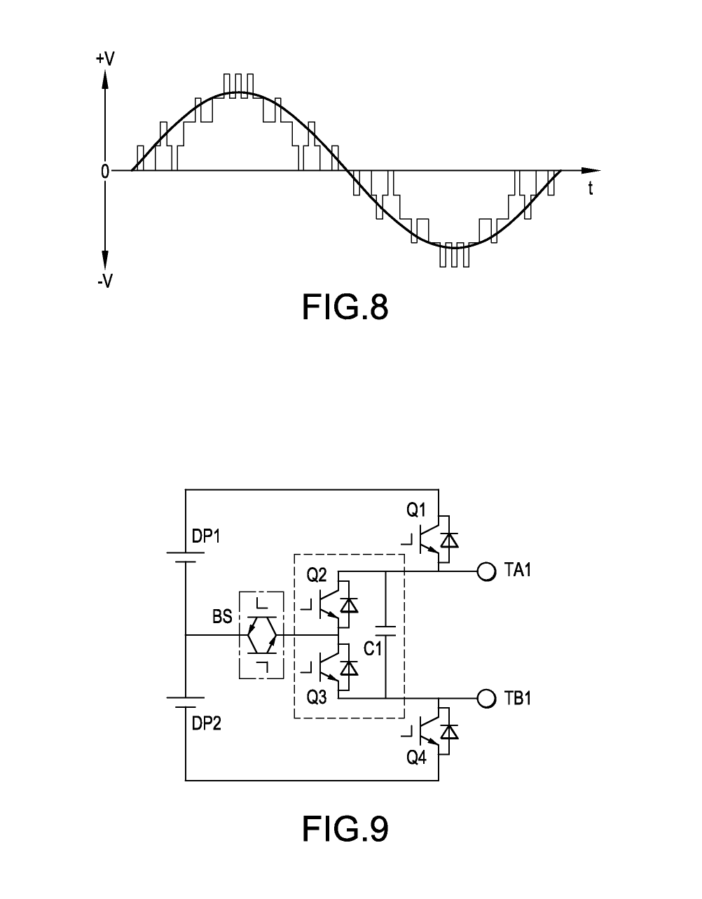

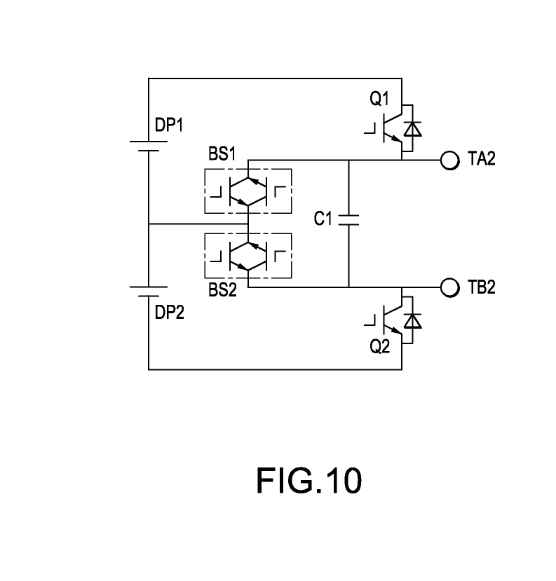

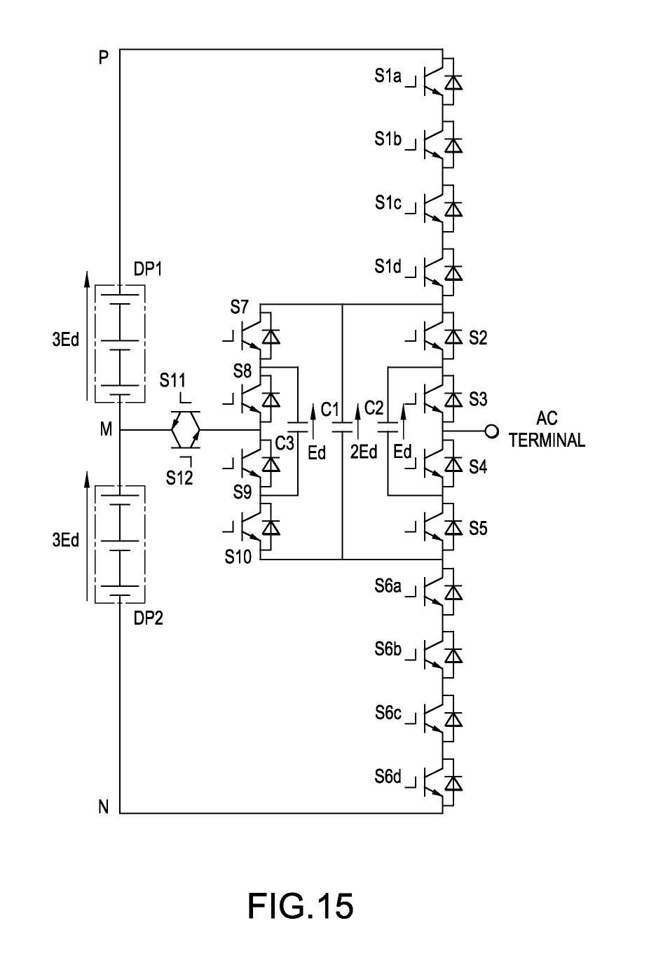

FIG. 5 shows Embodiment Example 2 of the present invention. Embodiment Example 2 is an example of application to a seven-level conversion circuit shown in FIG. 15. DC power supplies DP1 and DP2 each delivering a voltage of 3Ed are connected in series. The DC power supply circuit consisting of the DC power supplies DP1 and DP2 has a positive potential terminal P, a negative potential terminal N, and a middle potential terminal M. Twelve semiconductor switches S1a through S1d, S2, S3, S4, S5, S6a through S6d are connected in series between the positive potential terminal P and the negative potential terminal N. These semiconductor switches are IGBTs each having an antiparallel-connected diode. The semiconductor switches S1a through S1d are connected in series to compose a first semiconductor switch group, and the semiconductor switches S6a through S6d are connected in series to compose a second semiconductor switch group. The semiconductor switch S2 is referred to as a first semiconductor switch; the semiconductor switch S3, a second semiconductor switch; the semiconductor switch S4, a third semiconductor switch; and the semiconductor switch S5 is referred to as a fourth semiconductor switch. The first semiconductor switch group of semiconductor switches S1a through S1d, the first semiconductor switch S2, the second semiconductor switch S3, the third semiconductor switch S4, the fourth semiconductor switch S5, and the second semiconductor switch group of semiconductor switches S5a through S6d are connected in series in this order to compose a first semiconductor series circuit.

Between the node between the semiconductor switch S1d of the first semiconductor switch group and the first semiconductor switch S2 and the node between the fourth semiconductor switch S5 and the semiconductor switch S6a of the second semiconductor switch group, connected is a parallel circuit of a capacitor C1 and a second semiconductor switch series circuit consisting of semiconductor switches S7 through S10 connected in series. Capacitor C2 is connected in parallel with the series circuit of the second semiconductor switch S3 and the third semiconductor switch S4. Capacitor C3 is connected in parallel with the series circuit of the semiconductor switches S8 and S9. Between the middle potential terminal M, which is a series connection point between the DC power supply DP1 and the DC power supply DP2, and the node between the semiconductor switches S8 and S9, connected is a series circuit of a first bidirectional switch composed of antiparallel-connected reverse blocking IGBTs S11a and S12a capable of bidirectional switching and a second bidirectional switch composed of antiparallel-connected reverse blocking IGBTs S11b and S12b capable of bidirectional switching. The bidirectional switches can be constructed, in addition to the construction indicated in FIG. 5, by combining IGBTs without reverse blocking ability and diodes as shown in FIGS. 2A through 2D. Detailed description is omitted because they are same as those in Embodiment Example 1.

For the DC power supply circuit voltage 3Ed×2, seven levels of voltages can be obtained by charging a voltage of the capacitor C2 connected between the collector of the semiconductor switch S3 and the emitter of the semiconductor switch S4 at one unit of voltage Ed, charging a voltage of the capacitor C1 connected between the collector of the semiconductor switch S2 and the emitter of the semiconductor switch S5 at two units of voltage 2Ed, and charging a voltage of the capacitor C3 connected between the collector of the semiconductor switch S8 and the emitter of the semiconductor switch S9 at one unit of voltage Ed. As shown in FIG. 5, if all semiconductor switches have the same voltage rating, the first semiconductor switch group that corresponds to a semiconductor switch S1 is composed of four semiconductor switches S1a through S1d connected in series, and the second semiconductor switch group that corresponds to a semiconductor switch S6 is composed of four semiconductor switches S6a through S6d connected in series.

A system construction for short-circuit protection is same as the one in Embodiment Example 1. Two bidirectional switches are connected in series and the gate driving circuits for the bidirectional switches are provided with a circuit for detecting short-circuit fault in an OFF state. When a semiconductor switching device composing the bidirectional switch circuit suffers short-circuit fault, the gate driving circuit detects the fault and send out the detected signal to the control circuit, which in turn transmits an interruption signal to all semiconductor switches. Thus, the system is stopped without breaking the other normal semiconductor switches and capacitors. The gate driving circuit is same as the one in Embodiment Example 1: FIGS. 16A, 16B, and 16C show the circuit construction and the operation of the driving circuit.

While the above description has been made about a five-level conversion circuit and a seven-level conversion circuit, the present invention can be also applied to a multilevel conversion circuit of nine-level or higher levels. The semiconductor devices are IGBTs in the examples described so far. However, the present invention can be applied to circuits using MOSFETs or GTOs in place of IGBTs.

Embodiments of the invention relate to protection technology for a multilevel conversion circuit using a bidirectional switch circuit and thus, they are applicable to high voltage motor driving equipment, power conversion equipment for system interconnection, and other power conversion equipment.

What is claimed is:

1. A multilevel power conversion circuit for converting DC power to AC power or AC power to DC power, one phase of which comprising:
a first semiconductor switch series circuit connected between a positive potential terminal and a negative potential terminal of a DC power supply circuit having the positive potential terminal, the negative potential terminal, and a middle potential terminal, the first semiconductor switch series circuit being composed of:
a first semiconductor switch group composed of a plurality of semiconductor switches connected in series,
a first semiconductor switch,
a second semiconductor switch, and
a second semiconductor switch group composed of a plurality of semiconductor switches connected in series,
these four components being connected in series in this order;
a second semiconductor switch series circuit composed of a third semiconductor switch and a fourth semiconductor switch connected in series between a node between the first semiconductor switch group of the first semiconductor switch series circuit and the first semiconductor switch and a node between the second semiconductor switch and the second semiconductor switch group;
a capacitor connected in parallel with the second semiconductor switch series circuit; and
a bidirectional switch circuit capable of bidirectional switching connected between a series connection point of the second semiconductor switch series circuit and the middle potential terminal of the DC power supply circuit;
the multilevel power conversion circuit having an AC terminal at a series connection point between the first semiconductor switch and the second semiconductor switch; and
the bidirectional switch circuit having at least two semiconductor switching devices connected in series with the same current flowing direction.

2. A multilevel power conversion circuit for converting DC power to AC power or AC power to DC power, one phase of which comprising:
a first semiconductor switch series circuit connected between a positive potential terminal and a negative potential terminal of a DC power supply circuit having the positive potential terminal, the negative potential terminal, and a middle potential terminal, the first semiconductor switch series circuit being composed of:
a first semiconductor switch group composed of a plurality of semiconductor switches connected in series,
a first semiconductor switch through a fourth semiconductor switch, and
a second semiconductor switch group composed of a plurality of semiconductor switches connected in series,
these six components being connected in series in this order;
a second semiconductor switch series circuit composed of a fifth semiconductor switch through an eighth semiconductor switch connected in series between a node between the first semiconductor switch group of the first semiconductor switch series circuit and the first semiconductor switch and a node between the fourth semiconductor switch and the second semiconductor switch group;
a first capacitor connected in parallel with the second semiconductor switch series circuit;
a second capacitor connected in parallel with a series circuit of the second semiconductor switch and the third semiconductor switch;
a third capacitor connected in parallel with a series circuit of the sixth semiconductor switch and the seventh semiconductor switch; and
a bidirectional switch circuit capable of bidirectional switching connected between a node between the sixth semiconductor switch and the seventh semiconductor switch and the middle potential terminal of the DC power supply circuit;
the multilevel power conversion circuit having an AC terminal at a series connection point between the second semiconductor switch and the third semiconductor switch; and
the bidirectional switch circuit having at least two semiconductor switching devices connected in series with the same current flowing direction.

3. The multilevel power conversion circuit according to claim 1, wherein
the bidirectional switch circuit comprises at least two semiconductor switching devices connected in series with the same current-flow direction is connected to a control means that has a voltage detection means that detects a voltage applied between main terminals in an OFF signal period and determines that a semiconductor switching device composing the bidirectional switch circuit is in a fault state if the voltage detected by the voltage detection means is approximately zero in the OFF signal period and the control means stops the multilevel power conversion circuit.

4. The multilevel power conversion circuit according to claim 2, wherein
the bidirectional switch circuit comprises at least two semiconductor switching devices connected in series with the same current-flow direction is connected to a control means that has a voltage detection means that detects a voltage applied between main terminals in an OFF signal period and determines that a semiconductor switching device composing the bidirectional switch circuit is in a fault state if the voltage detected by the voltage detection means is approximately zero in the OFF signal period and the control means stops the multilevel power conversion circuit.

5. The multilevel power conversion circuit according to claim 3, wherein
the voltage detection means detects presence or absence of a current flowing in the OFF signal period from a gate driving circuit for driving the bidirectional switch circuit to the main terminal of the semiconductor switching device composing the bidirectional switch circuit to determine whether the voltage is approximately zero or not.

6. The multilevel power conversion circuit according to claim 4, wherein
the voltage detection means detects presence or absence of a current flowing in the OFF signal period from a gate driving circuit for driving the bidirectional switch circuit to the main terminal of the semiconductor switching device composing the bidirectional switch circuit to determine whether the voltage is approximately zero or not.

7. A multilevel power conversion circuit of nine levels or higher to which the multilevel power conversion circuit according to claim 1 is applied.

8. A multilevel power conversion circuit of nine levels or higher to which the multilevel power conversion circuit according to claim 2 is applied.
